(19) United States
(12) Patent Application Publication
(10) Pub. No.: US 2018/0283437 A1
(43) Pub. Date: Oct. 4, 2018

(54) ROLLED-THREAD BOLT PRODUCTION METHOD

(71) Applicant: TOYOTA JIDOSHA KABUSHIKI KAISHA, Toyota-shi (JP)

(72) Inventor: Taketo TAKEUCHI, Nishio-shi (JP)

(73) Assignee: TOYOTA JIDOSHA KABUSHIKI KAISHA, Toyota-shi (JP)

(21) Appl. No.: 15/933,945

(22) Filed: Mar. 23, 2018

(30) Foreign Application Priority Data
Mar. 29, 2017 (JP) 2017-064490

(51) Int. Cl. F16B 33/06; B21K 1/50; B21H 3/02; C21D 7/06

(52) U.S. Cl. CPC F16B 33/06; C21D 7/06; B21H 3/02; B21K 1/50

(57) ABSTRACT

A rolled-thread bolt production method includes: forming a steel wire into a workpiece having a prescribed unthreaded-bolt shape; forming a threaded-portion on the workpiece through thread rolling; and performing shot blasting on an entire surface of the workpiece after forming the threaded-portion.

### INCORPORATION BY REFERENCE

The disclosure of Japanese Patent Application No. 2017-064490 filed on Mar. 29, 2017 including the specification, drawings and abstract is incorporated herein by reference in its entirety.

### BACKGROUND

### 1. Technical Field

The disclosure relates to a rolled-thread bolt production method.

### 2. Description of Related Art

In order to produce a rolled-thread bolt, a steel wire that has been wound into a coil form is cut into pieces having a prescribed length, and then each piece is subjected to cold heading to be formed into an unthreaded bolt including a head having a prescribed shape and a stem that is integral with one end of the head. Then, a threaded-portion is formed, through thread rolling, in a distal-end-side region of the stem.

The related art section of Japanese Unexamined Patent Application Publication No. 2004-232757 (JP 2004-232757 A) refers to a technique in which shot blasting is performed after thread rolling and before a thermal treatment (i.e., between the thread rolling and the thermal treatment) in order to prevent reduction in the delayed fracture resistance by preventing a phosphorous component, which is contained in a phosphate lubrication coating film used for cold heading, from permeating into a bolt due to the thermal treatment performed after a threaded-portion is formed through the thread rolling. JP 2004-232757 A points out that, with the rerated art, the threaded-portion is easily damaged because the shot blasting is performed after the thread rolling. In view of this, JP 2004-232757 A describes that the shot blasting should be performed before a threaded-portion is formed through the thread rolling.

Note that phosphate lubrication coating, which has been employed for cold forging and the like for many years, requires a large-scale lubrication facility, requires a long treatment time, and produces sludge and waste fluid that place heavy burdens on the environment. In view of this, phosphate lubrication coating has been increasingly replaced with a treatment using a single-liquid lubricant. In this treatment, a workpiece only need to be immersed in a single liquid. Further, the single-liquid lubricant can be easily washed away by water or the like. With the use of the single-liquid lubricant, permeation of a phosphorous component into a bolt due to a thermal treatment no longer occurs.

### SUMMARY

If a threaded-portion is formed through thread rolling after shot blasting is performed, the surface roughness achieved by the shot blasting is reduced. Thus, the coefficient of friction at the time of tightening of a bolt is lower when thread rolling is performed after shot blasting than when shot blasting is performed after thread rolling. In view of this, there have been needs for a rolled-thread bolt production method that achieves a high coefficient of friction at the time of tightening of a bolt.

An aspect of the disclosure relates to a rolled-thread bolt production method including: forming a steel wire into a workpiece having a prescribed unthreaded-bolt shape; forming a threaded-portion on the workpiece through thread rolling; and performing shot blasting on an entire surface of the workpiece after forming the threaded-portion.

According to the rolled-thread bolt production method, it is possible to increase the coefficient of friction at the time of tightening of the rolled-thread bolt. This is because the shot blasting is performed after the threaded-portion is formed through the thread rolling, and thus the roughness of fine asperities formed through the shot blasting remains as it is.

In the rolled-thread bolt production method according to the above aspect of the disclosure, a frictional coefficient stabilizer may be applied to the workpiece after the shot blasting.

According to the rolled-thread bolt production method with this configuration, even if the frictional coefficient stabilizer melts at a high temperature, the frictional coefficient stabilizer can stay on the fine asperities formed through the shot blasting. It is therefore possible to suppress a decrease in the coefficient of friction of the rolled-thread bolt.

In the rolled-thread bolt production method according to the above aspect of the disclosure, the frictional coefficient stabilizer may be at least one of an engine oil-based lubricant, a molybdenum-based lubricant, and a graphite-based lubricant.

In the rolled-thread bolt production method according to the above aspect of the disclosure, a washer may be assembled to a columnar portion of the workpiece after the workpiece is formed and before the threaded-portion is formed.

In the rolled-thread bolt production method according to the above aspect of the disclosure, the washer may be subjected to the shot blasting while the shot blasting is performed.

With the rolled-thread bolt production method according to the above aspect, it is possible to increase the coefficient of friction at the time of tightening of the rolled-thread bolt.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a view of a rolled-thread bolt produced by a rolled-thread bolt production method according to an embodiment;

FIG. 2 is a flowchart illustrating steps of the rolled-thread bolt production method according to the embodiment; and

FIGS. 3A to 3E are views illustrating the details of the steps of the rolled-thread bolt production method in FIG. 2.

### DETAILED DESCRIPTION OF EMBODIMENTS

Hereinafter, example embodiments of the disclosure will be described in detail with reference to the accompanying drawings. While a bolt with a washer, which is used in a vehicle, will be described below as a rolled-thread bolt, the bolt is just an example for description and may be used for various purposes other than the use in a vehicle. A rolled-thread bolt without a washer or a rolled-thread bolt without a head may be adopted. The shapes, dimensions, materials, and so forth described below are just examples for description, and may be changed as appropriate in accordance with the specifications of a rolled-thread bolt. The same elements will be denoted by the same reference symbols in all the drawings, and description thereof will not be repeated.

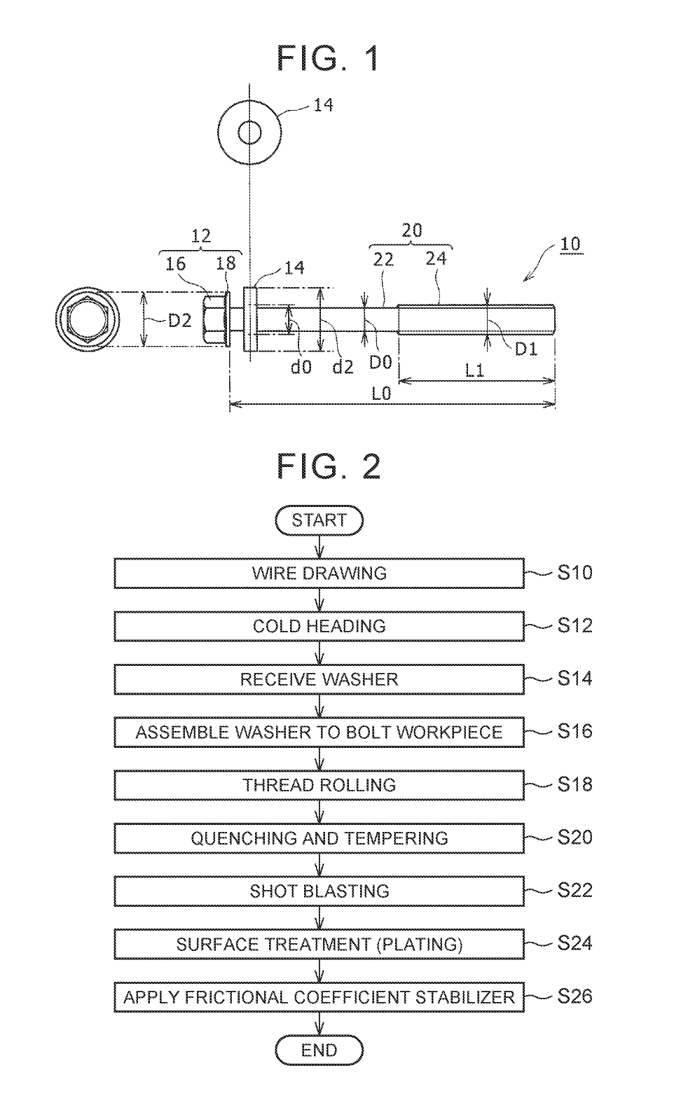

FIG. 1 is a view of a rolled-thread bolt 10. An overall view of the rolled-thread bolt 10 is illustrated in the right-side region in FIG. 1. A view of the rolled-thread bolt 10 as seen from the head-side of the rolled-thread bolt 10 is illustrated in the left-side region in FIG. 1. A view of a washer 14 as seen from the head-side of the rolled-thread bolt 10 is illustrated in the upper-side region in FIG. 1. The rolled-thread bolt 10 is a bolt for a vehicle, and is used to fasten vehicle parts to each other. The rolled-thread bolt 10 is a partially-threaded hexagon-head bolt with a washer. The rolled-thread bolt 10 includes a flanged hexagon head. The rolled-thread bolt 10 includes a head 12, a stem 20 that is integral with one end of the head 12, and the washer 14 disposed on the stem 20.

The head 12 includes a hexagonal portion 16, and a flange 18 called a washer head and having an outer diameter larger than that of the hexagonal portion 16. The stem 20 includes a columnar portion 22 that is an unthreaded-portion connected to the head 12, and a threaded-portion 24 extending from the columnar portion 22. The washer 14 is disposed on the columnar portion 22 that is a portion between the flange 18 of the head 12 and the threaded-portion 24 of the stem 20.

The threaded-portion 24 is an external thread formed through thread rolling. The overall length of the stem 20 will be denoted by L0 and the length of the threaded-portion 24 will be denoted by L1. The threaded-portion 24 is obtained by forming, through the thread rolling, an external thread on a portion having a length of L1 and included in a columnar workpiece having an overall length of about L0 before threading. The columnar portion 22 is a portion on which no external thread is formed. Thus, a root diameter (minor diameter) of the threaded-portion 24 is smaller than an outer diameter D0 of the columnar portion 22, and an outer diameter D1 (major diameter) of the threaded-portion 24 is larger than the outer diameter D0 of the columnar portion 22. The washer 14 is disposed on the columnar portion 22. An outer diameter d2 of the washer 14 is set to be larger than an outer diameter D2 of the flange 18 of the head 12, and an inner diameter d0 of the washer 14 is set to be larger than the outer diameter D0 of the columnar portion 22 and smaller than the outer diameter D1 of the threaded-portion 24. Thus, the washer 14 is assembled to the stem 20 such that the washer 14 is not detached from the stem 20.

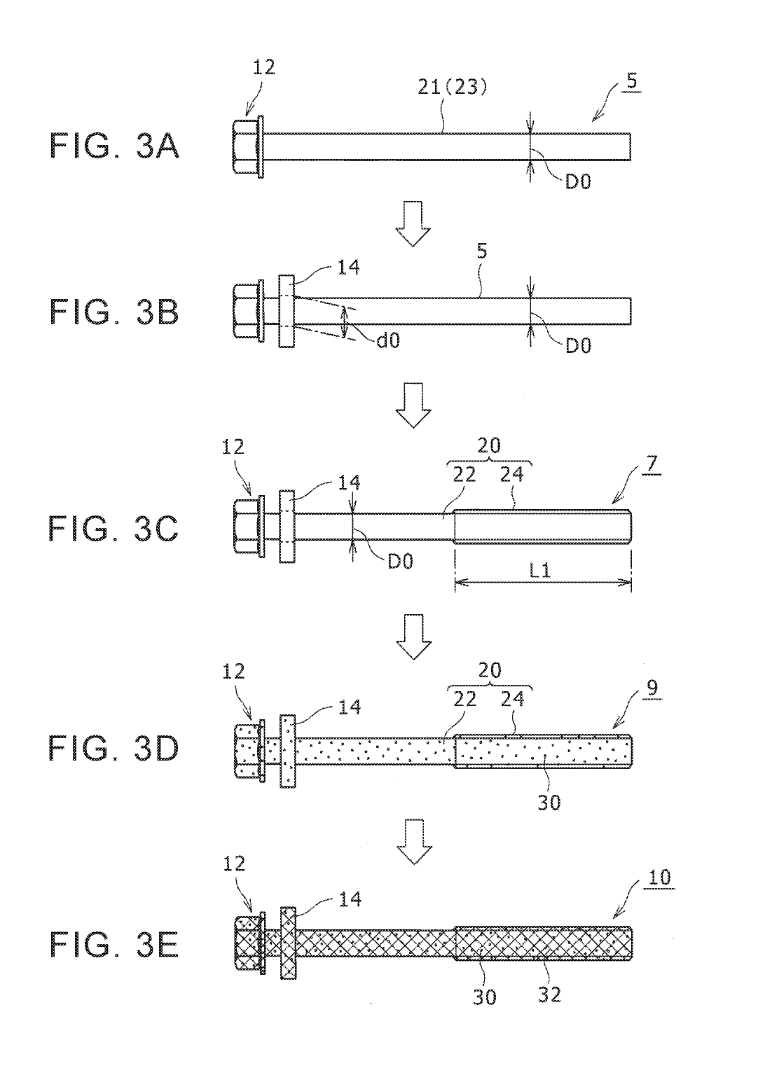

FIG. 2 is a flowchart illustrating steps of the method of producing the rolled-thread bolt 10 in FIG. 1. FIG. 3A to FIG. 3E are views illustrating the details of the steps of the method of producing the rolled-thread bolt 10. Hereinafter, the method of producing the rolled-thread bolt 10 will be referred to as “bolt production method” unless otherwise noted.

The first step of the bolt production method is a wire drawing step (S10). In the wire drawing step, a steel wire for a bolt, which has been wound in a coil form, is unwound straight and cut into pieces having a prescribed length. The steel wire for a bolt is obtained by forming a steel material having a property selected in advance into a wire having a circular section. The property of the steel material is determined based on the specifications of the rolled-thread bolt 10. For example, when the specifications are those for a high-strength bolt that is used for constructing various structures of a vehicle and that has a high tensile strength, a high-tension steel material, in which over ten kinds of elements, such as C, Si, Mn, and Ti, are managed by 0.0001%, is used.

Next, heading is performed (S12). Heading is a step in which each of the pieces obtained by cutting the steel wire at the prescribed length in the wire drawing step is formed, through cold heading, into an unthreaded bolt including a head having a prescribed shape and a stem having no thread. FIG. 3A illustrates a workpiece 5 having an unthreaded bolt shape. Hereinafter, unless otherwise noted, the workpiece 5 having an unthreaded bolt shape will be referred to as “bolt workpiece 5”. While the head 12 of the bolt workpiece 5 is formed in the same shape as that in FIG. 1, the threaded-portion 24 has not been formed on a stem 21, and only a columnar portion 23 having an outer diameter of D0 constitutes the stem 21 throughout the overall length of the stem 21. The overall length of the stem 21 is slightly different from the length L0 described with reference to FIG. 1, because thread rolling has not been performed yet. Examples of a lubricant that is used in heading include a single-liquid lubricant. When phosphate lubricant coating is employed, a phosphate coating film needs to be removed before a quenching and tempering step (described later) (S20) in order to prevent permeation of a phosphorous component into a bolt, which may otherwise occur during a thermal treatment.

After the bolt workpiece 5 having a prescribed shape is obtained, the bolt workpiece 5 receives the washer 14 that is prepared separately from the bolt workpiece 5 (S14), and the washer 14 is assembled to the bolt workpiece 5 (S16). The inner diameter d0 of the washer 14 is larger than the outer diameter D0 of the columnar portion 23 of the bolt workpiece 5, and the outer diameter d2 of the washer 14 is larger than the outer diameter D2 of the flange 18 of the head 12. Therefore, the columnar portion 23 of the bolt workpiece 5 is passed through an inner hole of the washer 14, and the washer 14 is disposed at a position where the washer 14 is stopped by the flange 18 of the head 12. FIG. 3B illustrates a state where the washer 14 has been assembled to the bolt workpiece 5.

Next, thread rolling is performed (S18) on the bolt workpiece 5 to which the washer 14 has been assembled. Through the thread rolling, the threaded-portion 24 having the length L1 is formed in a distal-end-side region of the columnar portion 23 of the bolt workpiece 5. The thread rolling is forging that is categorized into plastic working. The thread rolling is a method for forming an external thread by pressing the bolt workpiece 5 against hard dies while rotating the bolt workpiece 5, thereby forming the threaded-portion 24. FIG. 3C illustrates a rolled-thread bolt 7 formed through the thread rolling. At this stage, the outer shape of the rolled-thread bolt 7 is the same as that of the rolled-thread bolt 10 in FIG. 1.

Then, in order to obtain toughness, hardness, and so forth in accordance with the specifications of the rolled-thread bolt 10, a thermal treatment including prescribed quenching and tempering is performed (S20). The quenching is a treatment in which the rolled-thread bolt 7 is heated to a prescribed high temperature and then cooled suddenly. When oil quenching is employed, rust and the like hardly occur. The tempering is a treatment in which the material that has become harder but brittler due to the quenching is heated at a temperature lower than the quenching temperature and then cooled suddenly, so that the hardness is slightly reduced and the toughness (i.e., the ability of the material to absorb energy and plastically deform without fracturing) is recovered.

Next, shot blasting is performed (S22) on the entire surface of the rolled-thread bolt 7 after the quenching and tempering. The shot blasting is performed in order to form fine asperities on the surface of the rolled-thread bolt 7, thereby increasing the coefficient of friction at the time of tightening of the rolled-thread bolt 7. The shot blasting is a treatment in which grains called abrasive shot material are caused to collide with the entire surface of the rolled-thread bolt 7, whereby asperities are formed on the entire surface of each of the threaded-portion 24, the columnar portion 22, the washer 14, and the head 12. FIG. 3D illustrates a rolled-thread bolt 9 after the shot blasting. In FIG. 3D, fine asperities 30 formed through the shot blasting are indicated by small black dots.

Then, a surface treatment is performed (S24). The surface treatment is performed in order to improve the corrosion resistance of the rolled-thread bolt 9. In this case, a treatment for coating the surface of the rolled-thread bolt 9 with metal plating is performed. Examples of metal plating include zinc plating, nickel plating, and chrome plating. In place of metal plating, black oxide coating for forming a ferrosoferric oxide coating film on an iron surface may be performed.

After the surface treatment, a frictional coefficient stabilizer is applied to the rolled-thread bolt 9 (S26). The frictional coefficient stabilizer is a kind of lubricant that stabilizes the coefficient of friction at the time of tightening of the rolled-thread bolt 9 that has undergone the surface treatment. Examples of the frictional coefficient stabilizer include an engine oil-based lubricant, a molybdenum-based lubricant, and a graphite-based lubricant. FIG. 3E illustrates the rolled-thread bolt 10 that has undergone the surface treatment and application of the frictional coefficient stabilizer. Underneath a surface 32 that has undergone the surface treatment and application of the frictional coefficient stabilizer, there are the fine asperities 30 formed through the shot blasting. Thus, for example, even if the frictional coefficient stabilizer melts at a high temperature, the frictional coefficient stabilizer can stay on the fine asperities 30. It is therefore possible to suppress a decrease in the coefficient of friction. Thus, the rolled-thread bolt 10 having prescribed specifications illustrated in FIG. 1 is obtained. Note that FIG. 1 does not illustrate the fine asperities 30 formed through the shot blasting and the surface 32 that has undergone the surface treatment and application of the frictional coefficient stabilizer.

With the foregoing configuration, it is possible to increase the coefficient of friction at the time of tightening of the rolled-thread bolt 10. This is because the shot blasting is performed after the threaded-portion 24 is formed through the thread rolling, and thus the roughness of the fine asperities 30 formed through the shot blasting remains as it is. Further, even if the frictional coefficient stabilizer melts at a high temperature, the frictional coefficient stabilizer can stay on the fine asperities 30. Thus, it is possible to suppress a decrease in the coefficient of friction of the rolled-thread bolt 10.

In the foregoing method, the shot blasting (S22) is performed after the thermal treatment including quenching and tempering (S20). However, the order may be reversed, and the thermal treatment including quenching and tempering may be performed after the shot blasting.

In the method of producing the rolled-thread bolt 10 according to the present embodiment, the steel wire is formed into the bolt workpiece 5 having a prescribed unthreaded bolt shape (S12), and the workpiece 5 having an unthreaded bolt shape is subjected to the thread rolling to form the threaded-portion 24 (S18). Then, after the threaded-portion 24 is formed, the shot blasting is performed on the entire surface of the rolled-thread bolt 7 (S22).

According to the method of producing the rolled-thread bolt 10 having the foregoing configuration, it is possible to increase the coefficient of friction at the time of tightening of the rolled-thread bolt 10.

What is claimed is:

1. A rolled-thread bolt production method comprising:
forming a steel wire into a workpiece having a prescribed unthreaded-bolt shape;
forming a threaded-portion on the workpiece through thread rolling; and
performing shot blasting on an entire surface of the workpiece after forming the threaded-portion.

2. The rolled-thread bolt production method according to claim 1, further comprising applying a frictional coefficient stabilizer to the workpiece after the shot blasting.

3. The rolled-thread bolt production method according to claim 2, wherein the frictional coefficient stabilizer is at least one of an engine oil-based lubricant, a molybdenum-based lubricant, and a graphite-based lubricant.

4. The rolled-thread bolt production method according to claim 1, further comprising assembling a washer to a columnar portion of the workpiece after the workpiece is formed and before the threaded-portion is formed.

5. The rolled-thread bolt production method according to claim 4, wherein the washer is subjected to the shot blasting while the shot blasting is performed.
